(19) United States
(12) Patent Application Publication
(10) Pub. No.: US 2013/0099741 A1
(43) Pub. Date: Apr. 25, 2013

(54) IN-VEHICLE CHARGE CONTROL SYSTEM

(71) Applicants: Denso Corporation, Kariya-City (JP); Masashi Nakagawa, Toyota-shi (JP)

(72) Inventors: Takashi Shimizu, Kariya-city (JP); Masashi Nakagawa, Toyota-shi (JP)

(73) Assignees: DENSO CORPORATION, Kariya (JP); Masashi Nakagawa, Toyota-shi (JP)

(21) Appl. No.: 13/654,690

(22) Filed: Oct. 18, 2012

(30) Foreign Application Priority Data
Oct. 21, 2011 (JP) 2011-231976

(51) Int. Cl. H02J 7/00

(52) U.S. Cl. 320/109

(57) ABSTRACT

In an in-vehicle charge control system, a charge control section controls a charge device to start charging a traveling battery when a set determination section determines that a charge plug of an external power source is set to a charge port of a vehicle and a location determination section determines that the vehicle is at a location other than a base.

### CROSS REFERENCE TO RELATED APPLICATIONS

The present application is based on and claims priority to Japanese Patent Application No. 2011-231976 filed on Oct. 21, 2011, the contents of which are incorporated in their entirety herein by reference.

### TECHNICAL FIELD

The present disclosure relates to an in-vehicle charge control system.

### BACKGROUND

In a conventional charge control system, a midnight time is previously set as a charge starting time so that a charge is performed in a midnight power time zone in which an electricity rate is low. Then, at the charge starting time in a state where a charge plug of an external power source is set to a charge port of a vehicle, an in-vehicle charge device starts charging a traveling battery using electric power, supplied from the external power source.

In the charge control system, because the traveling battery is charged in the midnight power time zone, the electricity rate can be saved. However, if a charge amount of the traveling battery runs short at a location other than a base, such as home and office, in the daytime, a charge of the traveling battery is not started until a setting of the charge starting time is released once.

Thus, a user needs to release the charge starting time in order to charge the traveling battery and the user may feel troublesome.

### SUMMARY

It is an object of the present disclosure to provide an in-vehicle charge control system that can charge a traveling battery without releasing a setting of a charge starting time.

An in-vehicle charge control system for a vehicle according to an aspect of the present disclosure includes a charge device, a charge port, a set determination section, a charge time determination section, a first charge control section, a second charge control section, a base location storage section, a location detection section, a location, determination section, a third charge control section. The charge device charges a traveling battery using an electric power supplied from a charge plug of an external power source. The charge plug of the external power source is set to the charge port of the vehicle. The set determination section determines whether the charge plug of the external power source is set to the charge port. The charge time determination section determines whether a current time reaches a charge starting time that is previously set as a time to start charging the traveling battery. The first charge control section controls the charge device to start charging the traveling battery when the set determination section determines that the charge plug is set to the charge port and the charge time determination section determines that the current time reaches the charge starting time. The second charge control section prohibits the charge device from charging the traveling battery when the set determination section determines that the charge plug is set to the charge port and the charge time determination section determines that the current time does not reach the charge staring time. The base location storage section stores location information of a base of the vehicle. The location detection section detects current location information of the vehicle. The location determination section determines whether the vehicle is at a location other than the base based on the current location information detected by the location detection section and the location information stored in the base location storage section. The third charge control section controls the charge device to start charging the traveling battery when the set determination section determines that the charge plug is set to the charge port and the location determination section determines that the vehicle is at a location other than the base.

When a charge amount of the traveling battery runs short at a location other than the base, the in-vehicle charge control system can start charging the traveling battery by setting the charge plug of the external power source to the charge port without releasing a setting of the charge starting time.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram showing an in-vehicle charge control system according to an embodiment of the present disclosure;

FIG. 2 is a flowchart showing a registration process performed by a portable wireless terminal;

FIG. 3A to FIG. 3C are diagrams showing display contests of the portable wireless terminal in the registration process; and

FIG. 4 is a flowchart showing a charge control process performed by a controller in the in-vehicle charge control system.

### DETAILED DESCRIPTION

An in-vehicle charge control system 1 of an electric vehicle according to an embodiment of the present disclosure will be described with reference to the accompanying drawings.

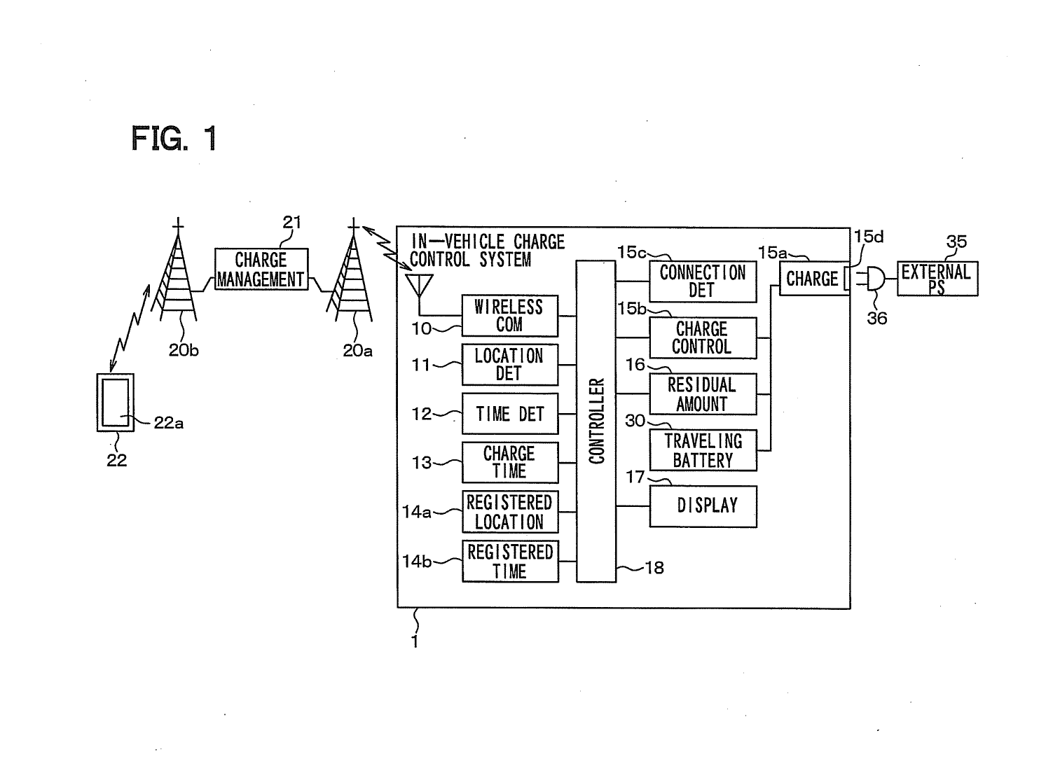

As shown in FIG. 1, the in-vehicle charge control system 1 includes a wireless communication part (WIRELESS COM) 10, a location detection device (LOCATION DET) 11, a time detection device (TIME DET) 12, a charge time management device (CHARGE TIME) 13, a registered location storage device (REGISTERED LOCATION) 14a, a registered time storage device (REGISTERED TIME) 14b, a charge device (CHARGE) 15a, a charge control device (CHARGE CONTROL) 15b, a connection detection device (CONNECTION DET) 15c, a battery residual amount management device (RESIDUAL AMOUNT) 16, a charge state display device (DISPLAY) 17, and a controller 18. The wires communication part 10, the location detection device 11, the time detection device 12, the charge time management device 13, the registered location storage device 14a, the registered time storage device 14b, the charge control device 15b, the connection detection device 15c, the battery residual amount management device 16, and the charge state display device 17 are coupled with the controller 18. The charge device 15a is coupled with the charge control device 15b, the battery residual amount management device 16, and a traveling battery 30.

The wireless communication part 10 communicates with a portable wireless terminal 22 via a base station 20a, a charge management center (CHARGE MANAGEMENT) 21, and a base station 20b. The base stations 20a, 20b are included in a mobile phone communication network. The base stations 20a, 20b are coupled with the charge management center 21 via a public network. The charge management center 21 relays communications between the wireless communication part 10 and the portable wireless terminal 22.

The portable wireless terminal 22 performs wireless communication with the base station 20b. The portable wireless terminal 22 includes a control portion. In the control portion, map information is previously stored. For example, the portable wireless terminal 22 is a terminal that includes a touch panel operated by a user. The portable wireless terminal is used for inputting a registered location and a charge starting time.

The location detection device 11 detects a current location of the electric vehicle based on an output signal of an in-vehicle sensor. For example, the in-vehicle sensor includes a geomagnetism sensor, a gyroscope, a vehicle sensor, and a GPS receiver. The location detection device 11 can operate as a location detection section. The time detection device 12 includes a watch and outputs a time signal that indicates a current time.

The charge time management device 13 repeatedly determines whether the current time reaches a charge starting time stored in the registered time storage device 14b and outputs a determination result to the controller 18. The registered time storage device 14b stores the charge starting time.

The registered location storage device 14a can operate as a location storage section. The registered location storage device 14 is a memory that stores information about registered location. The registered location is a location of a base of the electric vehicle. The base is a location where a user supposes to charge the traveling battery 30 at the charge starting time (e.g., midnight).

The registered time storage device 14b is a memory that stores the charge starting time. The registered time storage device 14b can operate as a charge starting time storage section.

The charge device 15a is a charge device for a normal charge. The charge device 15a rectifies an alternating voltage supplied from a charge plug 36 of an external power source (EXTERNAL PS) 35 via a charge port 15d and charges the traveling battery 30 based on a rectified direct voltage.

The charge port 15d is a charge port for a normal charge. The charge port 15d is disposed in the electric vehicle and is coupled with the charge plug 36 of the external power source 35. Accordingly, the charge port 15d is supplied with the alternating voltage from the external power source 35. The charge control device 15b controls the charge device 15a.

The connection detection device 15c detects whether the charge plug 36 is set to, that is, coupled to, the charge port 15d. For example, the connection detection device 15c includes a switch. When the charge plug 36 is not set to the charge port 15d, the switch is off. When the charge plug 36 is set to the charge port 13d, the switch is pressed by the charge plug 36 and the switch is turned on.

The battery residual amount management device 16 detects a charge amount of the traveling battery 30 and outputs a signal indicating the charge amount to the controller 18 and the charge control device 15b. The charge state display device 17 is controlled by the controller 18 and displays the charge amount of the traveling battery 30. The traveling battery 30 is a secondary battery that stores power to be supplied to a motor for traveling.

The controller includes a microcomputer and a memory. The controller 18 executes a charge control process in which a charge to the traveling battery 30 is started when the current time reaches the charge starting time or when the charge plug 36 of the external power source 35 is set to the charge port 15d at a location other than the base.

Next, an operation of the in-vehicle charge control system 1 will be described below.

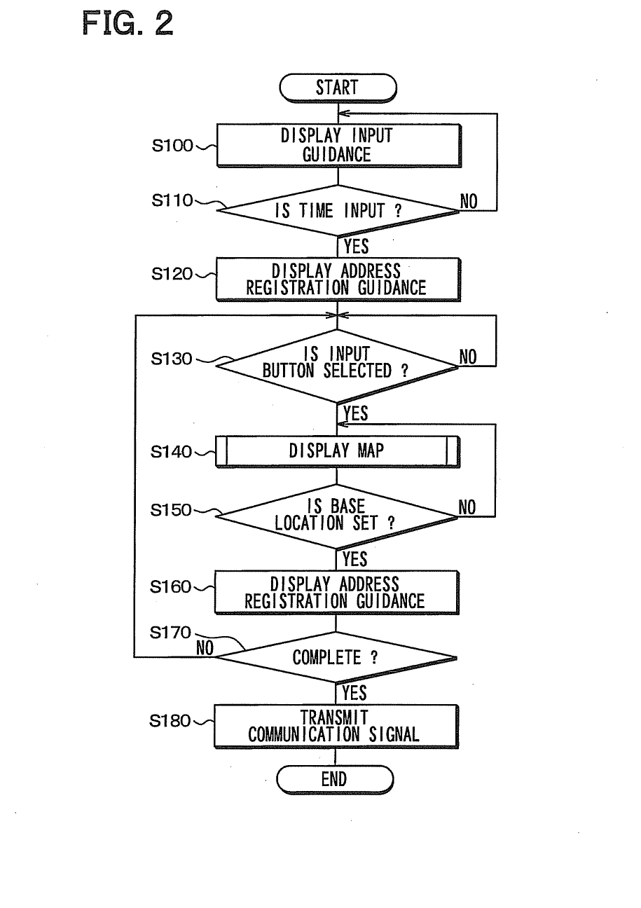

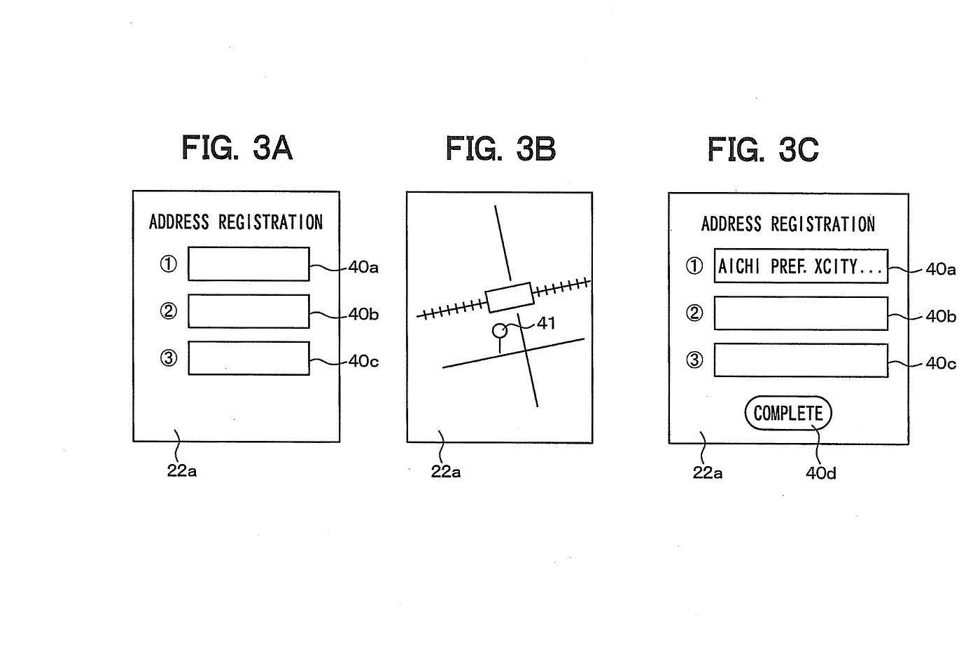

Before describing the charge control process by the controller 18, a registration process for inputting location information of the base and the charge starting time with the portable wireless terminal 22 will be described with reference to FIG. 2 and FIG. 3A to FIG. 3C.

The control portion of the portable wireless terminal 22 starts the registration process when a user operates the touch panel.

The portable wireless terminal 22 further includes a display portion 22a. At S100, the control portion controls the display portion 22a to display an input guidance so as to prompt a user to input a chargeable time. The chargeable time indicates one of the charge starting time and a charge ending time. Thus, at S100, the portable wireless terminal 22 waits for a user to input the charge starting time or the charge ending time.

The charge starting time is a time at which a charge to the traveling battery 30 starts. The charge ending time is a time at which the charge to the traveling battery 30 ends.

At S110, the control portion determines whether one of the charge starting time and the charge ending time is input. When the control portion determines neither the charge starting time nor the charge ending time is input, which corresponds to “NO” at S110, the process returns to S100. Thus, the control portion repeats the processes at S100 and S110 until one of the charge starting time and the charge ending time is input.

When the user inputs the charge starting time or the charge ending time by operating the touch panel, the control portion determines “YES” at S110.

Then, the process proceeds to S120 and the control portion controls the display portion 22a to display address registration guidance so as to prompt the user to register an address (location information) of the base of the electric vehicle. Thus, the portable wireless terminal 22 waits for the user to input the address of the base.

For example, in cases where the electric vehicle is a privately owned vehicle, the base may be a home of the user. In cases where the electric vehicle is a taxi, the base may be a taxi company. In cases where the electric vehicle is a company vehicle, the base may be a company that owns the company vehicle. However, even in cases where the electric vehicle is a privately owned vehicle, both a home and an office of the user may be registered as the base.

Thus at S120, the display portion 22a displays a plurality of input buttons 40a, 40b, 40c, as shown in FIG. 3A, so that a plurality of bases can be registered.

At S130, the control portion determines whether one of the input buttons 40a, 40b, 40c is selected. When the control portion determines that none of the input buttons 40a, 40b, 40c is selected, which corresponds to “NO” at S130, the controller repeats the determination at 5130 until one of the input buttons 40a, 40b, 40c is selected.

When the input button 40a is selected by the user by operating the touch panel, the control portion determines “YES” at S130 and the process proceeds to S140. At S140, the control portion controls the display portion 22a to display the map.

At S150, the control portion determines whether the location of the base is set in the map displayed in the display portion 22a. When the control portion determines that the location of the base is not set, which corresponds to “NO” at S150, the control portion repeats the processes at S140 and S150.

Based on the operation of the user to the touch panel, a pin 41 is set at a desired position in the map displayed in the display portion 22a. In the map, a position whether the pin 41 is placed is set as a first base. In other words, the first base is set by the operation of the user to the touch panel.

At S160, the control portion controls the display portion 22a to display the input buttons 40b, 40c, as shown in FIG. 3C, so that an address of another base can be registered. At this time, on the input button 40a, the address of the first base set with the pin 41, for example, “Aichi prefecture, X city . . . ” is displayed.

At S170, the control portion determines whether a complete button 40d on a display screen of the display portion 22a is selected, that is, the control portion determines whether the registration of the address of the base is completed. When the control portion determines that the registration of the address of the base is not completed, which corresponds to “NO” at S170, the process returns to S130.

The control portion repeats the processes at S130, S140, S150, S160, and S170 until the complete button 40d on the display screen of the display portion 22a is selected.

When the input button 40b is selected, the control portion determines “YES” at S130. Then, at S140, the display portion 22a displays the map. After that, another pin 41 is set at a desired position in the map based on an operation by the user to the touch panel. Accordingly, a second base is set to the map in the display portion 22a.

At S160, the display portion 22a displays the input button 40c and the complete button 40d so that an address of a base other than the first base and the second base can be registered. At this time, on the input button 40a, the address of the first base, for example, “Aichi prefecture, X city . . . ” is displayed. On the input button 40b, the address of the second base, for example, “Aichi prefecture, Y city . . . ” is displayed.

After that, when the complete button 40d is selected, the control portion determines “YES” at S170. At S180, the control portion transmits a communication signal including the charge starting time or the charge ending time input at S100 and the addresses (location information) of the first base and the second base set at S150.

When the base station 20b receives the communication signal, the base station 20b transmits the communication signal to the controller 18 via the charge management center 21, the base station 20a, and the wireless communication part 10 of the electric vehicle.

The controller 18 stores the addresses of the bases in the registered location storage device 14a. In addition, the controller 18 stores the charge starting time in the registered time storage device 14b.

When the user input the charge starting time to the portable wireless terminal 22 and the controller 18 receives the communication signal including the charge starting time via the base station 20b, the charge management center 21, the base station 20a, and the wireless communication part 10 of the electric vehicle, the controller 18 stores the charge starting time included in the communication signal in the registered time storage device 14b.

When the user input the charge ending time to the portable wireless terminal 22 and the controller 18 receives the communication signal including the charge ending time via the base station 20b, the charge management center 21, the base station 20a, and the wireless communication part 10 of the electric vehicle, the controller 18 calculates the charge starting time required for increasing the charge amount of the traveling battery 30 to be equal to or greater than a predetermined amount at the charge ending time based on the charge ending time included in the communication signal and the charge amount of the traveling battery 30 detected by the battery residual amount management device 16. Then, the controller 18 stores the calculated charge starting time in the registered time storage device 14b. The predetermined amount is, for example, 80% of the full charge.

The controller stores the charge starting time in the registered time storage device 14b as described above. Thus, the charge starting time is previously set before the controller 18 executes the charge control process.

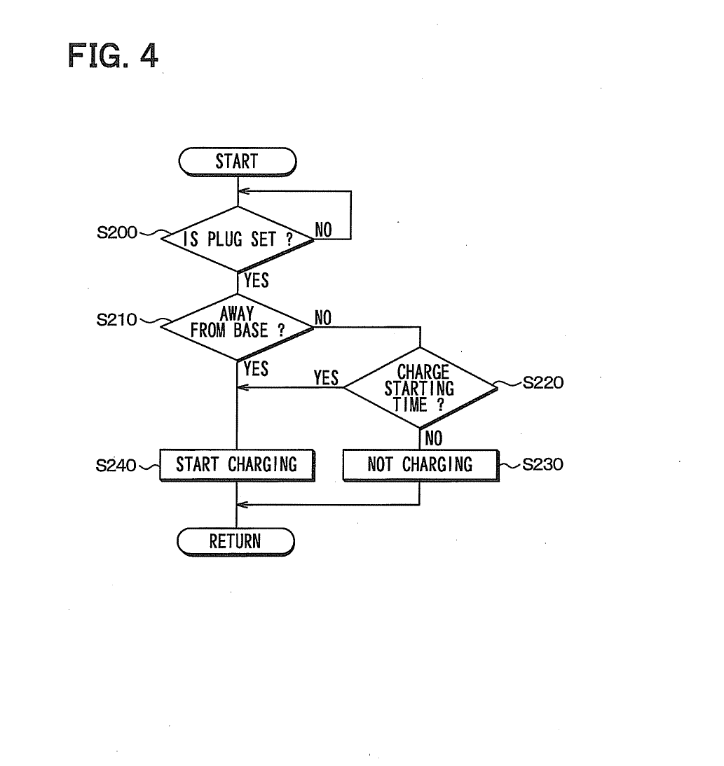

Next, the charge control process by the controller 18 will be described with reference to FIG. 4.

At S200, the controller 18 determines whether the charge plug 36 is set to the charge port 15d based on an output signal from the connection detection device 15c. When the controller 18 determines that the charge plug 36 is not set to the charge port 15d, the controller 18 repeats the determination at S200 until the charge plug 36 is set to the charge port 15d. When the charge plug 36 is set to the charge port 15d, the controller determines “YES” at S200. The controller 18 may include a set determination section, and the set determination section may perform the determination at S200.

At S210, the controller 18 determines whether the electric vehicle is at a location other than the base based on the current location information of the electric vehicle detected by the location detection device 11 and the location information of the bases stored in the registered location storage device 14a.

For example, the controller 18 determines whether the electric vehicle is at the location other than the base by determining whether the current location of the electric vehicle is equal to or more than a predetermined distance (e.g., 100 m) away from the bases.

For example, in cases where the location information of the first base and the second base are stored in the registered location storage device 14a, and a distance between the current location and one of the first base and the second base is less than the predetermined distance, the controller 18 determines that the electric vehicle is at the base, which corresponds to “NO” at S210, and the process proceeds to S220. The controller 18 may include a location determination section, and the location determination section may perform the determination at S210.

At S220, the controller 18 determines whether the current time reaches the charge starting time stored in the registered time storage device 14b based on an output signal from the charge time management device 13. The controller 18 may include a charge time determination section, and the charge time determination section may perform the determination at S220. When the current time does not reach the charge starting time, the controller 18 determines “NO” at S220. In this case, the process proceeds to S230, and the controller 18 prohibits the charge device 15a from the traveling battery 30. The controller 18 may include a second charge control section and the second charge control section may perform the process at S230.

When the controller 18 determines the charge plug 36 is set to the charge port 15d, which corresponds to “NO” at S200, the controller 18 determines that the electric vehicle is at the base, which corresponds to “NO” at S210, and the controller 18 determines that the current time reaches the charge starting time, which corresponds to “YES” at S220, the process proceeds to S240, and the controller 18 controls the charge device 15a via the charge control device 15b to start charging. The controller 18 may include a first charge control section and the first charge control section may perform the process at S240.

Accordingly, the charge device 15a rectifies the alternating current supplied from the charge plug 36 of the external power source 35 and charges the traveling battery 30. When the charge amount of the traveling battery 30 detected by the battery residual amount management device 16 becomes equal to or greater than the predetermined amount, the charge control device 15b controls the charge device 15a to stop charging the traveling battery 30.

Thus, when the user inputs the charge starting time to the portable wireless terminal 22, the charge device 15a starts charging at the charge starting time. When the user inputs the charge ending time, the charge amount of the traveling battery 30 becomes equal to or greater than the predetermined amount at the charge ending time, and the charge of the traveling battery 30 ends.

Then, the process returns to S200. When the controller 18 determines that the charge plug 36 is set to the charge port 15d, which corresponds to “YES” and the controller 18 determines that the electric vehicle is equal to or more than the predetermined distance away from the first base and the second based, the controller 18 determines “YES” at S210.

In this case, at S240, the controller 18 controls the charge device 15a via the charge control device 15b to start charging. Accordingly, the charge device 15a rectifies the alternating current supplied from the charge plug 36 of the external power source 35 and charges the traveling battery 30. When the charge amount of the traveling battery 30 detected by the battery residual amount management device 16 becomes equal to or greater than the predetermined amount, the charge control device 15b controls the charge device 15a to stop charging the traveling battery 30. The controller 18 may include a third charge control section, and the third charge control section may perform the process at S240.

In the charge control process according to the present embodiment, when the controller 18 determines that the charge plug 36 of the external power source 35 is set to the charge port 15d of the electric vehicle, which corresponds to “YES” at S200, and the controller 18 determines that the electric vehicle is equal to or more than the predetermined distance away from the base, which corresponds to “YES” at S210, the controller 18 controls the charge device 15a to start charging the traveling battery 30. Thus, when the charge amount of the traveling battery 30 runs short at a location other than the base, the charge to the traveling battery 30 can be started only by setting the charge plug 36 of the external power source 35 to the charge port 15d of the electric vehicle without releasing the setting of the charge starting time or the charge ending time. Thus, the user is restricted from feeling troublesome.

### Other Embodiments

In the above-described embodiment, the controller 18 determines whether the electric vehicle is at a location other than the base by determining whether the electric vehicle is equal to or more than the predetermined away from the base. In another embodiment, the controller 18 may determine whether the electric vehicle is at a location other than the base based on a determination result of whether the current location of the electric vehicle corresponds to the location information of the base.

When the current location of the electric vehicle corresponds to the location information of the base, the controller 18 may determine that the electric vehicle is not at a location other than the base. When the current location of the electric vehicle is different from the location information of the base, the controller 18 may determine that the electric vehicle is at a location other than the base.

In cases where the location information of a plurality of bases is stored in the registered location storage device 14a, the controller 18 may determine that the electric vehicle is at a location other than the bases when the current location of the electric vehicle is different from location information of any of the bases, and the controller 18 may determine that the electric vehicle is not at a location other than the bases when the current location of the electric vehicle corresponds to the location information of one of the bases.

In the above-described embodiment, at S120 and S160, the address registration guidance is displayed in the display portion 22a of the portable wireless terminal 22 so as to prompt a user to register the location information of the base. In another embodiment, it may be assumed that the electric vehicle is personally owned vehicle, and an address registration guidance for prompting a user to register a location information of a home may be displayed in the display portion 22a.

In this case, for example, when the location information of the home of the user is input to the portable wireless terminal 22, a communication signal including the location, information of the home is transmitted from the portable wireless terminal 22 to the wireless communication part 10 of the in-vehicle charge control system via the base station 20b, the charge management center 21, and the base station 20a. Then, the controller 18 stores the location information of the home in the registered location storage device 14a. At S210 in FIG. 4, the controller 18 may determine whether the electric vehicle is at a location other than the base by determining whether the electric vehicle is equal to or more than the predetermined distance away from the home.

In other words, in cases where the electric vehicle is assumed to be a personally owned vehicle of a user, the controller 18 previously stores location information of a home of the user. Then, the controller 18 may determine whether the electric vehicle is at a location other than the base by determining whether the electric vehicle is equal to or more than the predetermined distance away from the home.

In cases where the electric vehicle is assumed to be a company vehicle, the controller 18 may previously store location information of a company that owns the electric vehicle. Then, the controller 18 may determine whether the electric vehicle is at a location other than the base by determining whether the electric vehicle is equal to or more than the predetermined distance away from the company.

In cases where the electric vehicle is assumed to be a taxi, the controller 18 may previously store location information of a taxi company. Then, the controller 18 may determine whether the electric vehicle is at a location other than the base by determining whether the electric vehicle is equal to or more than the predetermined distance away from the taxi company.

In the above-described embodiment, at S120 in FIG. 2, the address registration guidance for prompting a user to register location information of a plurality of bases is displayed in the display portion 22a. In another embodiment, an address registration guidance for prompting a user to register location information of one base may be displayed in the display portion 22a.

In the above-described embodiment, the in-vehicle charge control system is applied to the electric vehicle. The in-vehicle charge control system may also be applied to a plug-in hybrid vehicle that includes a traveling engine and a traveling motor.

In the above-described embodiment, the current location of the electric vehicle is detected based on the output signal of the in-vehicle sensor. The current location of the electric vehicle may also be detected by acquiring a registration code set for each base station based on a communication signal transmitted from a base station of a movable body communication network.

In the above-described embodiment, the time is detected using the watch as the time detection device 12. In another embodiment, the time may also be detected using a time signal transmitted from a mobile phone communication network.

In the above-described embodiment, the connection detection device 15c detects whether the charge plug 36 is set to the charge port 15d using a switch. In another embodiment, the connection detection device 15c may communicate with the external power source 35 using a wire via the charge plug 36 and the charge port 15d and may detect whether the charge plug 36 is set to the charge port 15d based on the communication with the external power source 35.

In the above-described embodiment, a user registers the location information of the base and the charge starting time using the portable wireless terminal 22 that communicates with the controller 18 via the mobile phone communication network. In another embodiment, a user may register the location information of the base and the charge starting time (or the charge ending time) using a portable wireless terminal that communicates with the controller via short distance wireless communication such as wireless LAN and Bluetooth. In another embodiment, a user may register the location information and the charge starting time (or the charge ending time) by operating an operation portion disposed in a vehicle.

In the above-described embodiment, the charge device 15a starts charging the traveling battery 30 when the controller 18 determines that the charge plug 36 of the external power source 35 is set to the charge port 15d for the normal charge and determines that the electric vehicle is at a location other than the base. When an electric vehicle includes a rapid charge port and a rapid charge device, the rapid charge device may start charging the traveling battery 30 when the controller 18 determines that a charge plug of the external power source for a rapid charge is set to the rapid charge port and determines that the electric vehicle is at a location other than the base.

The external power source for the rapid charge supplies a direct voltage to the rapid charge device via the charge plug and the rapid charge port when the charge plug is set to the rapid charge port.

In the above-described embodiment, the charge device 15a starts charging the traveling battery 30 when the controller 18 determines that the charge plug 36 of the external power source 35 is set to the charge port 15d for the normal charge and determines that the electric vehicle is at a location other than the base. Furthermore, the in-vehicle charge control system may perform as the following (i) or (ii).

(i) In the electric vehicle including a rapid charge port and a rapid charge device, when the controller 18 determines that the charge plug of the external power source for the rapid charge is set to the rapid charge port, which corresponds to “YES” at S200, the controller 18 determines that the electric vehicle is at the base, which corresponds to “NO” at S210, and the controller 18 determines that the current time reaches the charge starting time, which corresponds to “YES” at S220, the controller 18 controls the charge device 15a to start charging the traveling battery 30, which corresponds to S240.

When the controller 18 determines that the charge plug of the external power source for the rapid charge is set to the rapid charge port, which corresponds to “YES” at S200, the controller 18 determines that the electric vehicle is at the base, which corresponds to “NO” at S210, and the controller 18 determines that the current time does not reaches the charge starting time, which corresponds to “NO” at S220, the controller 18 prohibits the charge device 15a from charging the traveling battery 30 at S230.

When the controller 18 determines that the charge plug of the external power source to the rapid charge is set to the rapid charge port, which corresponds to “YES” at S200, and the controller 18 determines that the electric vehicle is at a location other than the base, which corresponds to “YES” at S210, the controller 18 controls the charge device 15a to start charging the traveling battery 30 at S240 regardless of the current time.

(ii) in the electric vehicle including the rapid charge port and the rapid charge device, when the controller 18 determines that the charge plug of the external power source for the rapid charge is set to the rapid charge port, the controller 18 controls the rapid charge device to start charging the traveling battery 30 regardless of the current location of the electric vehicle and the current time.

What is claimed is:

1. An in-vehicle charge control system for a vehicle, comprising:
a charge device charging a traveling battery using an electric power supplied from a charge plug of an external power source;
a charge port of the vehicle to which the charge plug is set;
a set determination section determining whether the charge plug of the external power source is set to the charge port;
a charge time determination section determining whether a current time reaches a charge starting time that is previously set as a time to start charging the traveling battery;
a first charge control section controlling the charge device to start charging the traveling battery when the set determination section determines that the charge plug is set to the charge port and the charge time determination section determines that the current time reaches the charge starting time;
a second charge control section prohibiting the charge device from charging the traveling battery when the set determination section determines that the charge plug is set to the charge port and the charge time determination section determines that the current time does not reach the charge staring time,
a base location storage section storing location information of a base of the vehicle;
a location detection section detecting current location information of the vehicle;
a location determination section determining whether the vehicle is at a location other than the base based on the current location information detected by the location detection section and the location information stored in the base location storage section; and
a third charge control section controlling the charge device to start charging the traveling battery when the set determination section determines that the charge plug is set to the charge port and the location determination section determines that the vehicle is at the location other than the base.

2. The in-vehicle charge control system according to claim 1,
wherein the location determination section determines whether the vehicle at the location other than the base by determining whether the vehicle is equal to or more than a predetermined distance away from the base.

3. The in-vehicle charge control system according to claim 2,
wherein the base location storage section stores the location information of a plurality of the bases, and
wherein the third charge control section controlling the charge device to start charging the traveling battery when the set determination section determines that the charge plug is set to the charge port and the location determination section determines that the vehicle is equal to or more than the predetermined distance away from any of the bases.

4. The in-vehicle charge control system according to claim 2,
wherein the charge time determination section determines whether the current time reaches the charge starting time when the set determination section determines that the charge plug is set to the charge port and the location determination section determines that the vehicle is less than the predetermined distance away from the base.

5. The in-vehicle charge control system according to claim 1,
wherein the set determining section determines whether the charge plug of the external power source for a normal charge that supplies an alternating voltage to the charge device is set to the charge port of the vehicle.
